(19) United States
(12) Patent Application Publication
(10) Pub. No.: US 2019/0033782 A1
(43) Pub. Date: Jan. 31, 2019

(54) FLAP TOP LIGHT

(71) Applicant: Luminit, LLC, Torrance, CA (US)

(72) Inventors: Alkan Gulses, Gardena, CA (US); Seth Coe-Sullivan, Torrance, CA (US)

(21) Appl. No.: 16/045,360

(22) Filed: Jul. 25, 2018

Related U.S. Application Data
(60) Provisional application No. 62/537,188, filed on Jul. 26, 2017.

(51) Int. Cl. G03H 1/16; G02B 5/02

(52) U.S. Cl. CPC G03H 1/16; G02B 5/0215; G02B 5/0278; G02B 5/0263; G02B 5/0252

(57) ABSTRACT

The subject invention includes a Computer Generated Hologram fabricated with an Iterative Fourier Transform Algorithm combined with a low angle diffractive diffuser to result in uniform pattern.

### FIELD OF THE INVENTION

This invention is related to computer generated holograms (CGH), and more specifically, the use of a refractive diffuser to make a CGH output more uniform.

### BACKGROUND OF THE INVENTION

When generating an image for display on a planar surface through the use of a computer generated hologram (CGH), a common problem that is encountered is a hot-spot problem at the center. This occurs because of the fabrication erros and coding schemes (like quantization) of the CGH.

### SUMMARY OF THE INVENTION

The subject invention solves the issue of the central hot-spot of a CGH created image by combining a CGH with a low angle diffuser. The CGH is fabricated with an Iterative Fourier Transform Algorithm (IFTA) as known in the art. This CGH is then paired with a low angle diffractive diffuser, and the combination yields an output with uniform illumination, to create a flat top light.

The invention thus comprises a method of generating an image for display on a planar surface with the steps of fabricating a computer generated hologram (CGH) with an Iterative Fourier Transform Algorithm; utilizing unity in the CGH plane and the Iterative Fourier Transform Algorithm to reach the image plane at a certain phase; imposing a desired image amplitude while maintaining the phase; back propagating to the CGH plane and imposing the desired image amplitude; repeating steps b to d until the desired image is created; and pairing the CGH with a low angle diffractive diffuser.

### DESCRIPTION OF THE DRAWINGS

FIG. 1 is a schematic of a prior art light output from a CGH,

FIG. 2 is a schematic of the ideal output of a CGH and a diffuser according to the subject invention,

FIG. 3 is a schematic of a CGH partially fabricated with an IFTA and a low angle diffuser, with the resulting output.

FIG. 4 is a schematic of a CGH showing the desired output.

FIG. 5 is a schematic of an alternate output of a CGH and a diffuser.

### DETAILED DESCRIPTION OF THE PREFERRED EMBODIMENTS

Although the present invention is susceptible to embodiment in various forms, there are shown in the drawings and will hereinafter be described preferred embodiments with the understanding that the present disclosure is to be considered as an exemplification of the invention and is not intended to limit the invention to specific embodiments illustrated.

It is to be further understood that the title of this section of the specification, namely, “Detailed Description of the Preferred Embodiments” relates to a rule of the United States Patent and Trademark Office, and is not intended to, does not imply, nor should be inferred to, limit the subject matter disclosed herein or the scope of the invention.

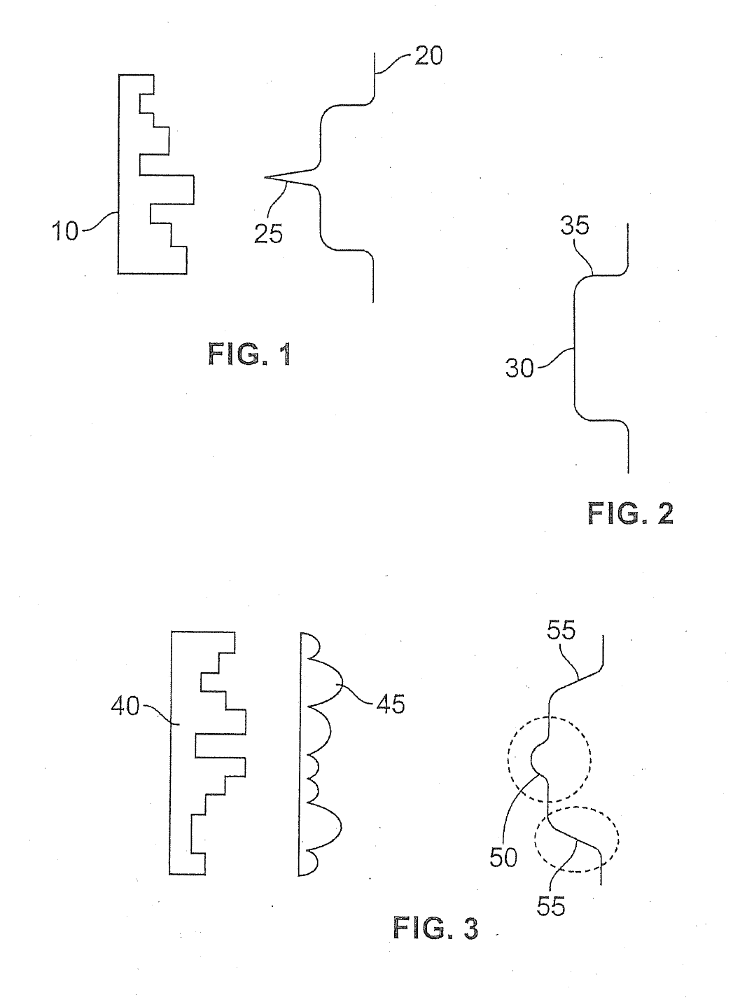

Referring now to FIG. 1, there is shown a CGH 10, with an output 20. The output 20 highlights the problem of non-uniformity present, in that the output 20 has an extra bright spot 25, found at the center. This bright spot cannot be eliminated through a redesign of the CGH alone.

FIG. 2 shows the ideal output desired when displaying an image by these means. There is a flat upper surface 30, with sharp sides 35. This output represents uniform illumination.

In order to achieve the result shown in FIG. 2, a CGH is designed, utilizing a computer as known in the art, with an Iterative Fourier Transform Algorithm (IFTA). One such algorithm is the Gerchberg-Saxton Algorithm, although others may be used, as well, as known in the art. With the IFTA, one starts with a unity field at the CGH plane and uses the Iterative Fourier transform to reach the image plane. Then the desired image amplitude is imposed, while the phases are maintained. One then back-propagates to the CGH plane and the amplitude is again imposed. In this case, since the CGH is phase only, the amplitude remains unity, while the phase remains the same. The above constitutes one iteration and the process is repeated until the desired image and thus uniformity of the image is created.

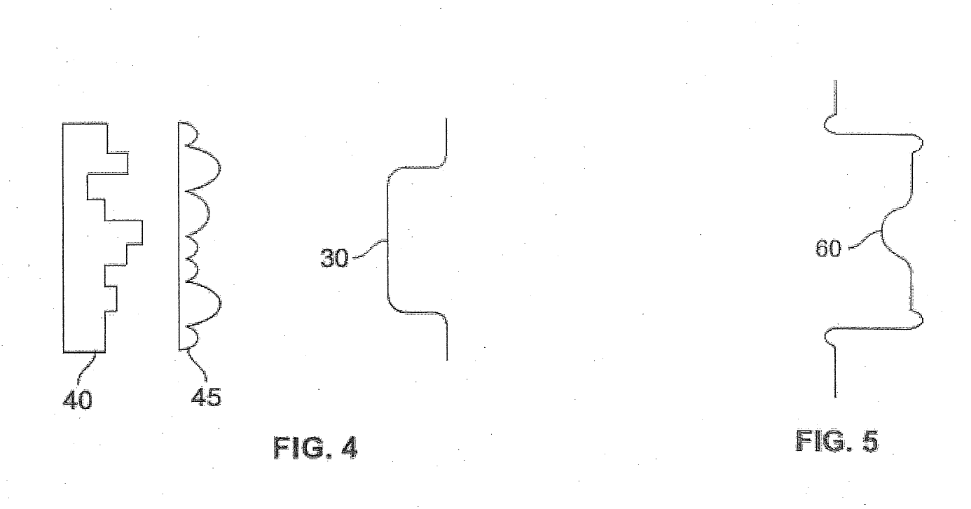

Normally the above process would be sufficient to produce an acceptable, but not perfect, image as in FIG. 1. When it is combined with a diffractive diffuser having a low diffusion angle of 0.5 to 2 degrees output, such as that shown in FIG. 3 should be the result. The output from this combination has edge slopes 55 that are more apparent, due to blurring, and are directly proportional to the diffuser angle. As a result, it becomes necessary to further develop the CGH. In this manner, one can achieve a truly uniform image.

However, a hologram may also be designed to cancel out the undesired effects of the diffuser. The result is output 60 in FIG. 5. Now the base hologram is designed for a slightly modified output for the central spot and edge slopes.

Following the above iterative process for the desired output, again and combining the thus-formed CGH 40 with a low-angle refractive diffuser 45 results in the disappearance of the bright spot and the edge slopes. Thus, as shown in FIG. 4, the output is the desired flat top light with the zero-spot smoothed over. The diffuser must be at a low angle to ensure operation. The CGH is formed of an epoxy covered substrate where the phase relief profile of the CGH is encoded into the epoxy. As shown in the figures the diffuser is placed between the epoxy covered substrate and the image. The diffuser is generally pseudorandom, as opposed to the CGH, which is deterministic.

It will be understood that the foregoing description is of preferred exemplary embodiments of the invention and that the invention is not limited to the specific forms shown or described herein. Various modifications may be made in the design, arrangement, and type of elements disclosed herein, as well as the steps of making and using the invention without departing from the scope of the invention as expressed in the appended claims. One such embodiment is to add the effects of CGH and a diffuser on the same plane by adding their phase functions.

1. A method of generating an image for display on a planar surface comprising the steps of:
a) fabricating a computer generated hologram (CGH) with an Iterative Fourier Transform Algorithm;
b) utilizing unity in the CGH plane, and the Iterative Fourier Transform Algorithm to reach the image plane at a certain phase; comprising the steps of
i) imposing a desired image amplitude while maintaining the phase;
ii) back propagating to the CGH plane and imposing the desired image amplitude;
iii) repeating steps b to d until the desired image is created; and
c) pairing the CGH with a low angle diffractive diffuser.

2. The method of claim 1 wherein the low angle diffuser has a diffusion angle of 0.5 to 2 degrees.

3. A computer generated hologram for forming an image having maximum uniformity, said hologram comprising an epoxy coated substrate, with the phase relief profile embedded in the epoxy; a pseudo-random refractive diffuser placed between the epoxy coated substrate and the image, the diffuser having a diffusion angle of between 0.5° and 2.0°.
